(19) United States
(12) Patent Application Publication
(10) Pub. No.: US 2013/0257010 A1
(43) Pub. Date: Oct. 3, 2013

(54) Automatic Braking Device and Method

(71) Applicants: Melvin G. Hector, JR., Tucson, AZ (US); Dana R. Yentzer, Tucson, AZ (US)

(72) Inventors: Melvin G. Hector, JR., Tucson, AZ (US); Dana R. Yentzer, Tucson, AZ (US)

(21) Appl. No.: 13/598,349

(22) Filed: Aug. 29, 2012

Related U.S. Application Data
(60) Provisional application No. 61/529,233, filed on Aug. 30, 2011.

(51) Int. Cl. A61G 5/10; A61G 5/02

(52) U.S. Cl. CPC A61G 5/101; A61G 5/02
USPC 280/250.1; 188/2 F; 29/428

(57) ABSTRACT

An automatic braking assembly and method are provided, where the automated braking assembly is formed as a complete unit, and is configured to be connected with a manually propelled vehicle. The automatic braking assembly that is formed as a complete unit includes (a) a housing, and (b) an automatic braking mechanism supported within the housing. The housing is configured to be connected with a portion of the vehicle to locate the automatic braking assembly in a predetermined position relative to a wheel of the vehicle, such that the automatic braking assembly will lock the wheel against movement when an occupant of the vehicle begins to rise from a seated position in the vehicle.

### RELATED APPLICATION/CLAIM OF PRIORITY

This application is related to and claims the priority of U.S. Provisional Application No. 61/529,233, filed Aug. 30, 2011, and entitled Automatic Braking Device and Method, which provisional application is incorporated by reference herein.

### INTRODUCTION

The present invention relates to an assembly that can be integrated into a manually propelled vehicle such as a wheel chair at the time the vehicle is constructed, and can also be retrofitted to a manually propelled vehicle such as a wheel chair, to provide the vehicle with an automatic locking device that is triggered to lock the wheels of the vehicle when a patient starts to rise from the wheel chair.

Applicants' U.S. application Ser. No. 12/716,875, filed Mar. 3, 2010, and entitled Structure, Components and Method for Constructing and Operating an Automatically self locking manually propelled vehicle such as a wheel chair, a copy of which is attached as exhibit A, and which is incorporated by reference herein, discloses a new and useful concept for providing a manually prepared vehicle such as a wheel chair with an automatic braking feature. The braking feature can be integrated into the wheel chair at the time the wheel chair is constructed, and can also be retrofitted to an existing wheel chair.

The present invention provides a device that is consistent with the concept of U.S. application Ser. No. 12/716,875, in providing an automatic locking device for a manually propelled vehicle such as a wheel chair, and provides a preferred configuration for this device that can be retrofitted to an existing such vehicle.

One aspect of the present invention comprises an automatic locking assembly configured to be connected with a manually propelled vehicle. The automatic locking assembly includes (a) a housing, and (b) an automatic braking mechanism supported within the housing. The housing is configured to be connected with a portion of the vehicle to locate the automatic locking assembly in a predetermined position relative to a wheel of the vehicle, such that the automatic locking assembly will lock the wheel against movement when an occupant of the vehicle begins to rise from a seated position in the vehicle.

Another aspect of the present invention comprises a manually propelled vehicle comprising a structural frame having
i. At least one wheel,
ii. a seat frame,
iii. a seat for a vehicle occupant, and
iv. an automatic locking assembly connected with the frame,

The automatic locking mechanism comprises (a) a housing, and (b) an automatic braking mechanism supported within the housing; where the housing is connected with a portion of the vehicle frame to locate the automatic locking assembly in a predetermined position relative to the wheel of the vehicle, such that the automatic locking assembly will lock the wheel against movement when an occupant of the vehicle begins to rise from a seated position in the vehicle.

It should also be noted that a unique feature of the invention of exhibit A and also of the present invention, is that they each provide the manually propelled vehicle with the characteristic of being automatically locked at all times unless it is volitionally unlocked. Specifically, the automatic locking assembly is configured such that it continues to lock the wheel against movement until the automatic locking assembly is unlocked from the wheel.

Still another aspect of the present invention is a method for providing a manually propelled vehicle with an automatic locking capability. The method comprises (a) providing a manually propelled vehicle that comprises a seat connected with a seat frame, and at least one wheel, (b) providing an automatic locking assembly configured to be connected with the manually propelled vehicle, where the automatic locking assembly comprises (i) a housing, and (ii) an automatic braking mechanism supported within the housing, where the housing is configured to be connected with a portion of the vehicle to locate the automatic locking assembly in a predetermined position relative to a wheel of the vehicle, such that the automatic locking assembly will lock the wheel against movement when an occupant of the vehicle begins to rise from a seated position in the vehicle, and (c) connecting the automatic locking assembly with the seat frame at a location and orientation such that the automatic locking assembly will lock the wheel against movement when an occupant of the vehicle begins to rise from a seated position in the vehicle

Other features of the present invention will become further apparent from the following detailed description and the accompanying drawings.

### BRIEF DESCRIPTION OF THE DRAWINGS

FIG. 1 is a side and rear end view of an automatic braking assembly (360) according to the present invention, where the side view omits cover plate (380), and further showing features of an encased brake platform (329) part of the assembly;

FIG. 2 is a side view of one of the cover plates (380) forming part of the automatic braking assembly of the present invention;

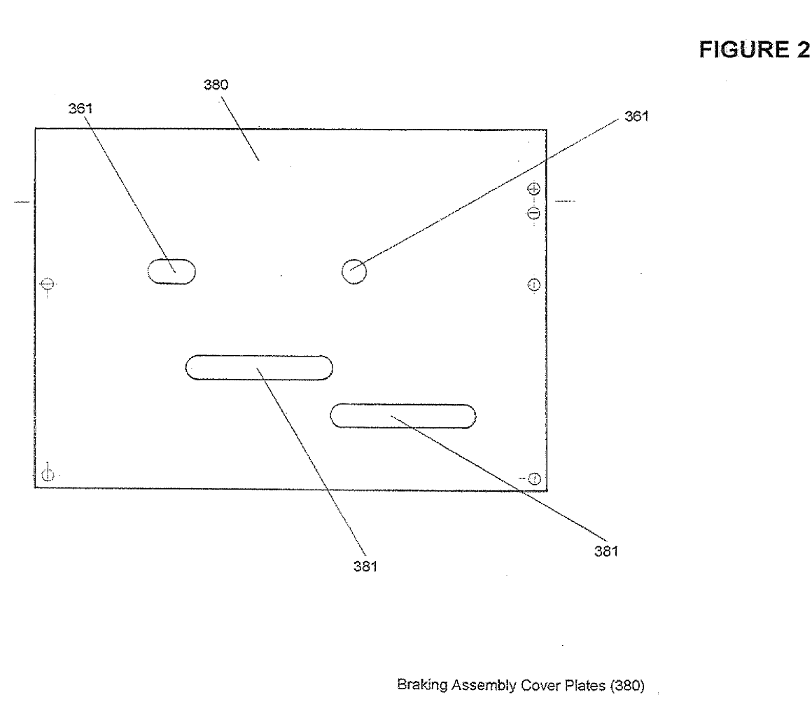

FIG. 3 is an overview of an automatic braking assembly (360) according to the present invention, showing a side view that omits cover plate (380), an end view and features of the encased brake platform, all when the automatic braking mechanism of the assembly is in an “auto locked” position when a vehicle occupant starts to rise from the vehicle and the seat of the vehicle is decompressed;

FIG. 4 shows views of the auto braking mechanism, from the vantage of FIG. 3, but in a state where the brake mechanism is in a “cocked” position when the vehicle seat is occupied and compressed;

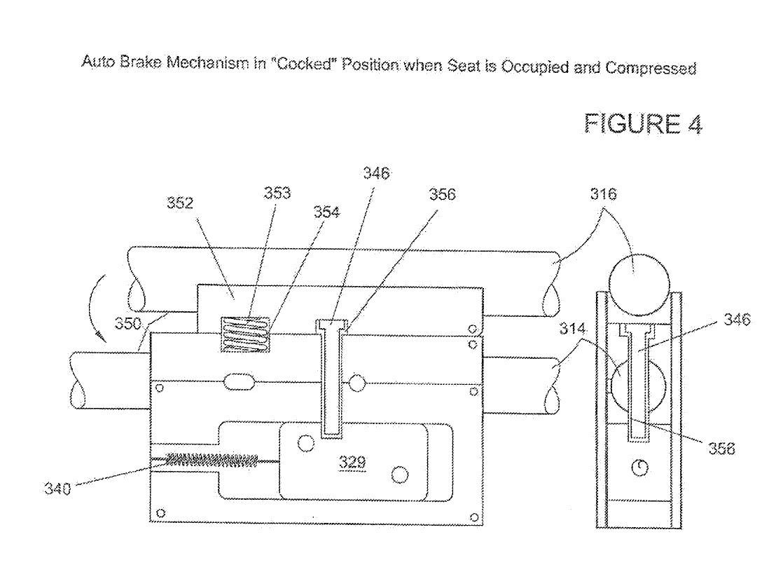

FIG. 5 is a three dimensional view of a manual brake assembly thru bolt assembly for an automatic braking assembly according to the present invention;

FIG. 6 illustrates a side view of a cover plate and locking clip assembly in the automatic braking assembly of the present invention; and

FIG. 7 illustrates an auto lock floating pin extending through a chair rail in an automatic braking assembly of the present invention.

### DETAILED DESCRIPTION

As discussed above, the present invention relates to a new and useful automatic braking assembly and method that is particularly useful with a wheelchair. The principles of the present invention are described in connection with an automatic braking assembly for a wheel chair and from that description, the manner in which the principles of the present invention can also be applied to other types of manually controlled vehicles will be apparent to those in the art.

The automatic braking assembly and method shown and described in

Exhibit A explains the manner in which an automatic braking mechanism automatically locks the wheel of a manually propelled vehicle such as a wheel chair, as soon as an occupant starts to rise from the seat of the vehicle. Those principles are maintained and utilized in an automatic locking assembly according to the present invention. The present invention supplements the invention of Exhibit A by providing an automatic braking assembly that is a complete unit that can be fabricated as a unit and integrated into a manually propelled vehicle such as a wheel chair at the time the vehicle is constructed, and can also be retrofitted to a manually propelled vehicle such as a wheel chair, to provide the vehicle with an automatic braking device that is triggered to lock the wheels of the vehicle when an occupant starts to rise from the wheel chair.

Thus, applicants' U.S. application Ser. No. 12/716,875, filed Mar. 3, 2010, and entitled Structure, Components and Method for Constructing and Operating an Automatically self locking manually propelled vehicle such as a wheel chair, a copy of which is attached as exhibit A, and which is incorporated by reference herein, discloses the basic structure and operating principles that provide a new and useful way of providing a manually propelled vehicle such as a wheel chair with an automatic braking feature. From the description of that application, the manner in which an automatic braking assembly of the present invention will function to automatically lock the wheels of a wheel chair when an occupant of the wheel chair begins to rise from the wheel chair seat will be apparent to those in the art. The automatic braking assembly of the present invention is specifically designed as a complete unit that can be integrated into the wheel chair at the time the wheel chair is constructed, and can also be retrofitted to an existing wheel chair.

One aspect of the present invention comprises an automatic locking assembly 360 configured to be connected with a manually propelled vehicle. The automatic locking assembly 360 includes a pair of cover plates 380 forming part of a housing, and an automatic braking mechanism supported within the housing. This provides an automatic braking assembly that is a complete unit. The housing is configured to be connected with a portion of the vehicle frame to locate the automatic locking assembly in a predetermined position relative to a wheel of the vehicle, such that the automatic locking assembly will lock the wheel against movement when an occupant of the vehicle begins to rise from a seated position in the vehicle, in the manner described in detail in Exhibit A. The manually propelled vehicle comprises a structural frame having at least one wheel, a seat frame, a seat for a vehicle occupant, and, the automatic braking assembly 360 is connected with the frame, and functions in the manner described in U.S. application Ser. No. 12/716,875 (exhibit A),

It should also be noted that a unique feature of the invention of exhibit A and also of the present invention, is that they each provide the manually propelled vehicle with the characteristic of being automatically locked at all times unless it is volitionally unlocked. Specifically, the automatic braking assembly 360 is configured such that it continues to lock the wheel against movement until the automatic locking assembly is unlocked from the wheel. In addition, a manual braking assembly 322 is connected to the brake platform 329 and extends out of the housing. The manual braking assembly functions in a conventional manner to provide the vehicle with a manual braking capability that operates in addition to the automatic braking mechanism, as also described in U.S. application Ser. No. 12/716,875 (exhibit A).

In a method according to the principles of U.S. application Ser. No. 12/716,875, and the present invention, (a) a manually propelled vehicle is provided that comprises a seat connected with a seat rail (316), and at least one wheel, (b) an automatic locking assembly 360 is configured to be connected as a unit with the manually propelled vehicle, where the automatic locking assembly comprises (i) a housing, and (ii) an automatic braking mechanism supported within the housing, where the housing is configured to be connected with a portion of the vehicle to locate the automatic locking assembly in a predetermined position relative to a wheel of the vehicle, such that the automatic locking assembly will lock the wheel against movement when an occupant of the vehicle begins to rise from a seated position in the vehicle. The automatic braking assembly is connected as a unit with the seat frame at a location and orientation such that the automatic braking assembly will lock the wheel against movement when an occupant of the vehicle begins to rise from a seated position in the vehicle, in accordance with the principles of U.S. application Ser. No. 12/716,875 (exhibit A).

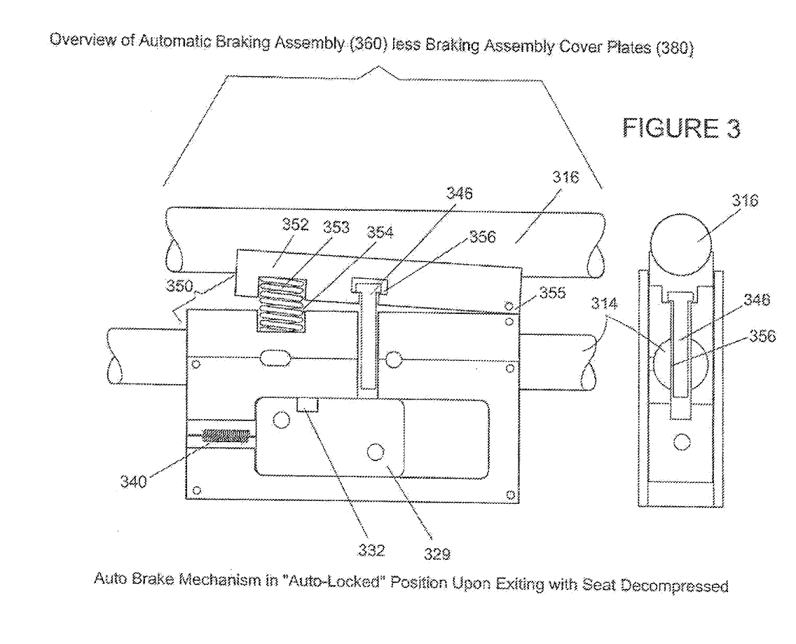

As described herein, the automatic braking assembly 360 of the present invention comprises a housing formed by a pair of cover plates 380, and an assembly of components disposed between the cover plates. FIG. 3 schematically illustrates many of the internal components of the automatic braking system assembly that are disposed between the cover plates 380. Those components include a compression plate 352, and its hinge assembly 355, an auto lock floating pin recess 356 for the auto lock floating pin 346, a compression lift spring 353 in its recesses 354 and the compression lift spring assembly 350. Those components are configured and function according to the principles of U.S. application Ser. No. 12/716,875 (Exhibit A).

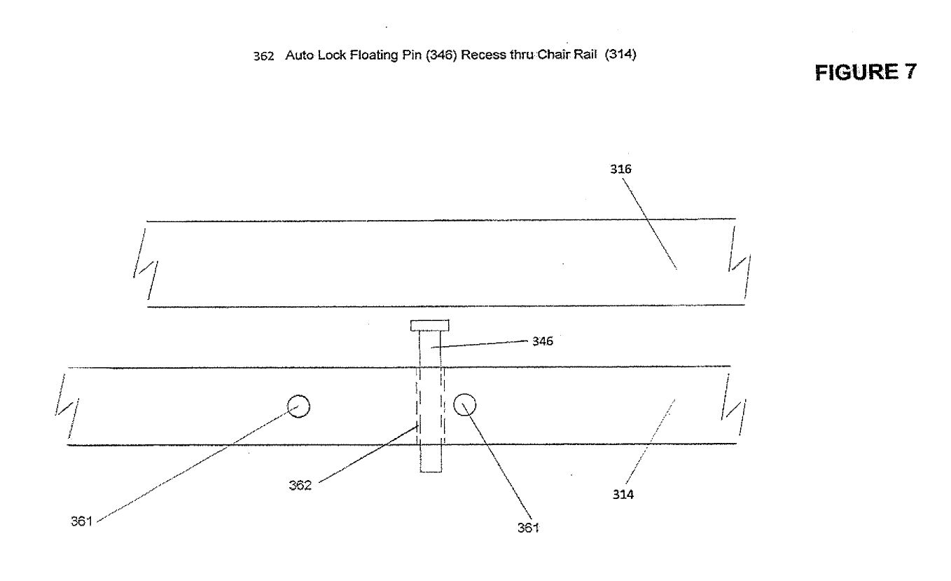

As shown in FIG. 7, a recess hole 362, referred to as a floating pin recess is machined into the chair rail (314) allowing the Auto Lock Floating Pin 346 to operate, in a manner according to the principles of U.S. application Ser. No. 12/716 (Exhibit A).

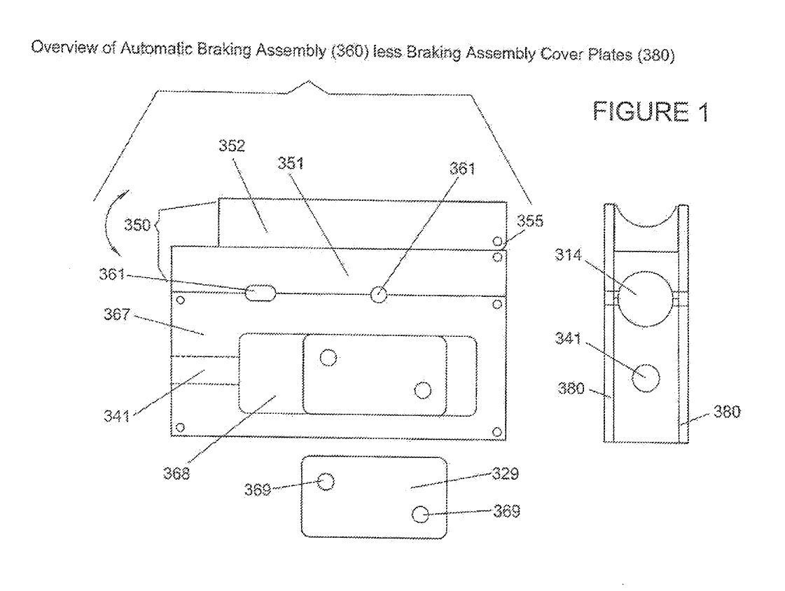

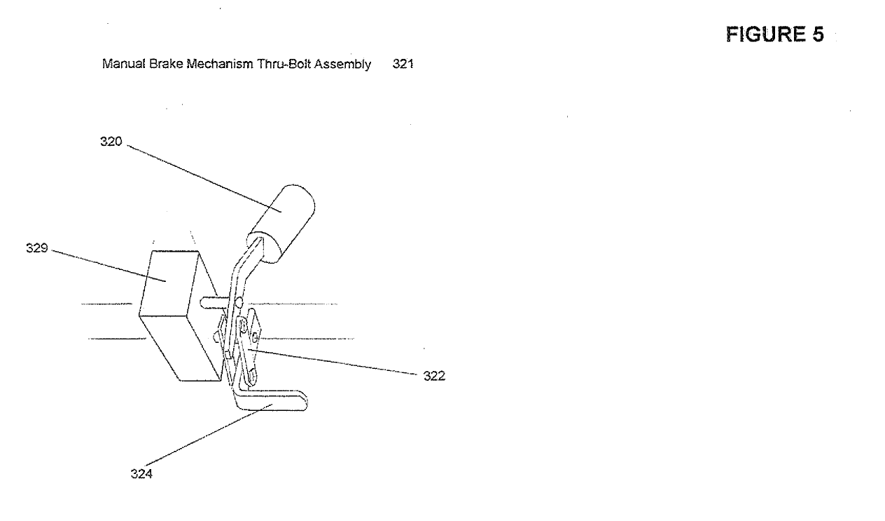

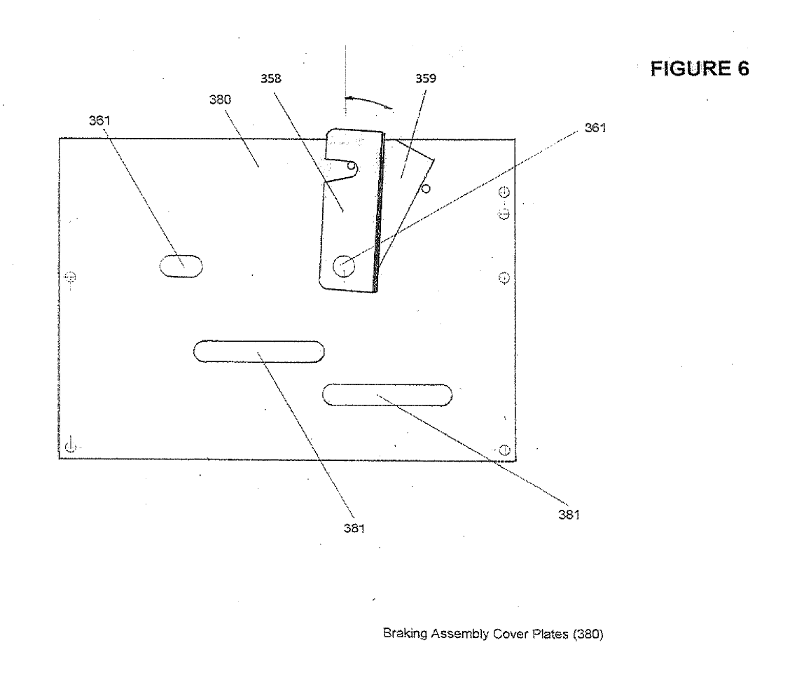

As shown in FIG. 1, a braking platform encasement block 367 includes holes 361 for mounting it to the existing seat rail 316, and a depression 368 in which the encased brake platform 329 travels (see FIG. 1). The auto lock tension spring 340 (FIG. 3) drives the brake platform 329 to lock the wheelchair when the occupant rises from the seat of the wheelchair as the compression lift spring 353 (FIG. 3) lifts the auto lock floating pin 346 out of the auto lock brake floating pin receiver hole 332 in the brake platform. The mounting holes 369 (FIG. 1) for the manual brake mechanism 322 (FIG. 5) in the encased brake platform 329 (FIG. 1) are where the manual brake mechanism attaches to the brake platform. The locking clip assembly 358 on each side is used to lock the compression lift spring assembly 350 closed, duplicating the effect of an occupant seated in the chair, so that the chair can then be moved by unlocking the manual brake mechanism 322 (FIG. 5). Thus the automatic braking assembly 360, an assembly that always locks the wheelchair unless it is disengaged, may be disengaged without an occupant for purposes of transport and cleaning, etc. There is a locking clip assembly indicator 359 (FIG. 6) on the cover plate (380) that is visible from a distance, that will alert a trained observer that the automatic locking assembly is “turned off”, and, in fact the vehicle may be used in this setting indefinitely for a patient who has no need for an automatic locking device, making it function like any other self propelled vehicle such as a wheel chair, i.e., unlocked until it is volitionally locked. If the existing wheelchair configuration does not have a separate chair rail 314 and seat rail 316, the auto lock floating pin 346 (FIG. 3) interface may be configured so that it is attached in one of several methods to the undercarriage of the seat material itself, and still accomplish the action of a spring-loaded withdrawal when the patient rises and reinsertion of the pin when the patient sits and then re-cocks the mechanism as described in U.S. application Ser. No. 12/716,875 (Exhibit A).

It should also be noted that with the present invention, the seat rail 316 and the chair rail 314 move away from each other, and the compression plate 352 can pivot relative to the other half of the compression spring lift assembly 350 (FIG. 3), in the manner described herein, to initiate the automatic braking sequence.

Thus, as seen from the foregoing description and figures, an automatic braking assembly and method are provided, where the automated braking assembly is formed as a complete unit, and is configured to be connected with a manually propelled vehicle. The automatic braking assembly that is formed as a complete unit includes (a) a housing, and (b) an automatic braking mechanism supported within the housing. The housing is configured to be connected with a portion of the vehicle to locate the automatic braking assembly in a predetermined position relative to a wheel of the vehicle, such that the automatic braking assembly will lock the wheel against movement when an occupant of the vehicle begins to rise from a seated position in the vehicle. The manner in which the automatic braking mechanism is configured and functions to automatically lock the wheel of the vehicle when the occupant begins to rise from the seat of the vehicle is in accordance with the principles of U.S. application Ser. No. 12/716,875 (Exhibit A).

With the foregoing disclosure in mind, it is believed that various adaptations of an automatic braking assembly that is configured as a complete unit, can be attached as a complete unit to a vehicle frame, and functions according to the principles of the present invention and of U.S. application Ser. No. 12/716,875, will be apparent to those in the art.

1. An automatic locking assembly configured to be connected with a manually propelled vehicle, comprising
a. a housing, and
b. an automatic braking mechanism supported within the housing;
c. the housing configured to be connected with a portion of the vehicle to locate the automatic locking assembly in a predetermined position relative to a wheel of the vehicle, such that the automatic locking assembly will lock the wheel against movement when an occupant of the vehicle begins to rise from a seated position in the vehicle

2. A manually propelled vehicle comprising a structural frame with
a. at least one wheel,
b. a seat frame,
c. a seat for a vehicle occupant, and
d. an automatic locking assembly connected with the frame,
e. the automatic locking mechanism comprising
i. a housing, and
ii. an automatic braking mechanism supported within the housing;
iii. the housing connected with a portion of the vehicle frame to locate the automatic locking assembly in a predetermined position relative to a the wheel of the vehicle, such that the automatic locking assembly will lock the wheel against movement when an occupant of the vehicle begins to rise from a seated position in the vehicle

3. The manually propelled vehicle of claim 2, wherein the automatic locking assembly is configured such that it continues to lock the wheel against movement until the automatic locking assembly is unlocked from the wheel.

4. The manually propelled vehicle of claim 3, wherein the manually propelled vehicle includes a seat rail and a chair rail, and wherein the automatic braking mechanism includes a compression plate that moves relative to the chair rail to initiate locking of the wheel against movement when the occupant begins to rise from a seated position in the vehicle.

5. A method for providing a manually propelled vehicle with an automatic locking capability, comprising
a. providing a manually propelled vehicle that comprises a seat connected with a seat frame, and at least one wheel,
b. providing an automatic locking assembly configured to be connected with the manually propelled vehicle, the automatic locking assembly comprising
i. a housing, and
ii. an automatic braking mechanism supported within the housing,
iii. the housing configured to be connected with a portion of the vehicle to locate the automatic locking assembly in a predetermined position relative to a wheel of the vehicle, such that the automatic locking assembly will lock the wheel against movement when an occupant of the vehicle begins to rise from a seated position in the vehicle, and
c. connecting the automatic locking assembly with the seat frame at a location and orientation such that the automatic locking assembly will lock the wheel against movement when an occupant of the vehicle begins to rise from a seated position in the vehicle.

6. The method of claim 5, wherein the manually propelled vehicle includes a seat rail and a chair rail, and wherein the automatic braking mechanism includes a compression plate that moves relative to the chair rail to initiate locking of the wheel against movement when the occupant begins to rise from a seated position in the vehicle.

7. A manually propelled vehicle so designed that has the characteristic of being automatically locked at all times unless it is volitionally unlocked.
